(19) United States
(12) Patent Application Publication
(10) Pub. No.: US 2008/0196627 A1
(43) Pub. Date: Aug. 21, 2008

(54) Vitreous enamel coating powder

(75) Inventor: Derek W. Sproson, Queenstown, MA (US)

Correspondence Address: LARRY J. GUFFEY, WORLD TRADE CENER - SUITE 1800, 401 EAST PRATT STREET, BALTIMORE, MD, 21202, US

(73) Assignee: Core Technologies, Inc.

(21) Appl. No.: 11/707,514

(22) Filed: Feb. 16, 2007

(51) Int. Cl. C04B 28/24

(52) U.S. Cl. 106/287.34; 427/222

(57) ABSTRACT

An improved method for making an enamel coating powder includes the steps of: (a) forming an aqueous suspension of prescribed percentages of sol-gel glass formers, powdered glass filler and additives, wherein the additives are chosen so as give the resulting vitreous enamel coating the desired decorative and functional properties, (b) converting this suspension into particles having a prescribed particle size distribution, (c) heating the particles to drive off water and salt anions that are chemically bound to the particles, and (d) coating the particles so as to provide them with the degree of resistivity required for use with dry electrostatic spray systems.

### BACKGROUND OF THE INVENTION

1. Field of the Invention

This invention relates to an improved vitreous enamel powder and its method of manufacture. More particularly, in a preferred embodiment, the present invention relates to an improved enamel coating powder that is formulated for use in dry electrostatic spray systems.

2. Description of the Related Art

Various formulations of enamel coating powders are known to exist that can be electrostatically sprayed onto metallic target surfaces. These powders, upon firing or exposure to high temperatures, are fused together so as to form a vitreous layer on the target's surface.

Enamel coating powders are usually formulated from specialty glasses that are conventionally melted and then rapidly cooled by quenching so as to yield what is referred to as a glass frit. Several of these frits may be combined to yield the desired coating powder. This combination of frits is then milled to a fine powder state.

To be electrostatically sprayable, these coating powders must have a sufficiently high electric volume resistivity, customarily 10⁹ to 10¹⁴ Ω.m. In order to attain these required resistivity value, these coating powders can be coated with insulating substances (e.g., silanols and organopolysiloxanes, isocyanates, carbodiimides, organosilicon compounds, organotitanium compounds, waxes, fatty acids (e.g., stearic, palmatic, oleic)). It is also known to include various additives (e.g., pigments, opacifiers, adhesion agents) to these powders which are advantageous in helping to determine the final properties of the resulting enameled surfaces.

The relevant technology in this field is disclosed in assorted publications. See, for example, U.S. Pat. Nos. 3,928,668, 3,930,062, 4,059,423, 4,063,916, 4,082,860, 4,476,156, 5,100,451, 5,213,598, 5,393,714, 5,534,348, 5,589,222, 6,270,854, 6,350,495, 6,517,904, 6,800,333 and 6,831,027. See also “Manual of Electrostatic Porcelain Enamel Powder Application,” (1997), Porcelain Enamel Institute, Nashville, Tenn.

Fault-free electrostatic coating presupposes that the volume resistivity of the coating power is matched to the substrate to be coated and to the climate conditions. However, problems can arise in this matching due to volume resistivity differences attributable to differences in: (a) frit glass compositions, (b) particle size distributions created during the milling operation (thereby requiring screening and classification of the resulting powders), and (c) the uniformity with which additives can be applied to the powder.

Thus, despite extensive technology in this area, there continues to be a need for improved vitreous enamel coating powders that can be used in dry electrostatic spray systems.

3. Objects and Advantages

There has been summarized above, rather broadly, the prior art that is related to the present invention in order that the context of the present invention may be better understood and appreciated. In this regard, it is instructive to briefly consider the objects and advantages of the present invention.

It is an object of the present invention to provide an improved enamel coating powder and its method of manufacture.

It is also an object of the present invention to provide an improved enamel coating powder that is suitable for use in dry electrostatic spray systems.

It is further an object of the present invention to provide a new enamel coating powder, and its method of manufacture, that has improved uniformity throughout the powder in its electric volume resistivity.

It is additionally an object of the present invention to provide a new vitreous enamel powder that can be produced by a simpler, lower cost, more environmentally friendly and less energy consuming manufacturing process.

These and other objects and advantages of the present invention will become readily apparent as the invention is better understood by reference to the accompanying summary, drawings and the detailed description that follows.

### SUMMARY OF THE INVENTION

Recognizing the need for the development of improved, vitreous enamel coating powders and their methods of manufacture, the present invention is generally directed to satisfying the needs set forth above and overcoming the limitations seen in the prior art powders and their methods of manufacture.

In accordance with a first embodiment of the present invention, an improved method for making an enamel coating powder, that is used to form on a surface a vitreous enamel coating having desired decorative and functional properties, includes the steps of: (a) forming an aqueous suspension of prescribed percentages of sol-gel glass formers, powdered glass filler and additives, wherein the additives are chosen SO as give the resulting vitreous enamel coating the desired decorative and functional properties, (b) converting this suspension into particles having a prescribed particle size distribution, and (c) heating the particles to drive off water and salt anions that are chemically bound to the particles.

In a second embodiment, the present invention further includes the step of coating the particles with siloxanes or other suitable materials so as to provide them with the degree of resistivity required for use with dry electrostatic spray systems.

In further embodiments, the present invention entails either of the enamel coating powders that result from utilizing the improved manufacturing methods of the either of the first two embodiments noted above.

Thus, there has been summarized above, rather broadly and understanding that there are other preferred embodiments which have not been summarized above, the present invention in order that the detailed description that follows may be better understood and appreciated.

### BRIEF DESCRIPTION OF THE DRAWINGS

FIG. 1 schematically illustrates the steps involved in a preferred embodiment of the present invention.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The present invention remedies many of the prior problems with nonuniformities in the volume resistivity levels throughout such powders by formulating and producing them with simpler, lower cost, more environmentally friendly and less energy consuming manufacturing processes.

In a first embodiment, the present invention takes the form of an improved method for making an enamel coating powder and includes the steps of: (a) forming an aqueous suspension of prescribed percentages of sol-gel glass formers, powdered glass filler and additives, wherein the additives are chosen so as give the resulting vitreous enamel coating the desired decorative and functional properties, (b) converting this suspension into particles having a prescribed particle size distribution, (c) heating the particles to drive off water and salt anions that are chemically bound to the particles, and (d) coating the particles with siloxanes or other suitable materials so as to provide them with the degree of resistivity required for use with dry electrostatic spray systems. Alternatively, the present invention can be considered to be the enamel coating powders that result from utilizing such an improved manufacturing process.

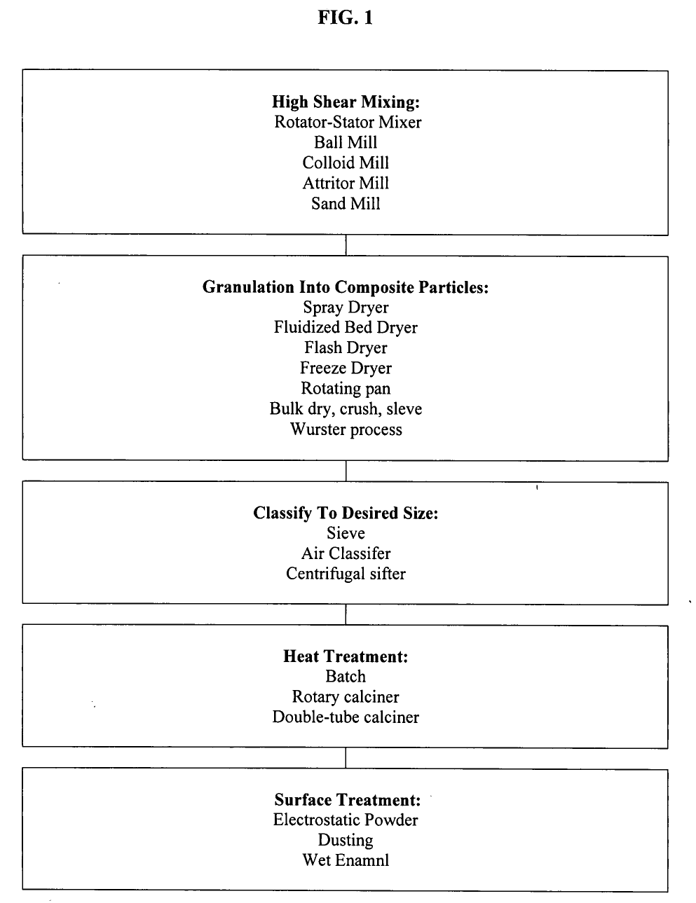

The means and methods for achieving these steps, in a first preferred embodiment, are outlined and shown schematically in FIG. 1. This manufacturing process begins by mixing colloidal (sol-gel) glass forming constituents or precursors, fillers and selected additives in water using a high shear mixer (e.g., rotor-stator type). For a sodium boro silicate colloidal glass precursor, an appropriate amount of boric acid or borax is dissolved in hot water. Appropriate amounts of sodium silicate and colloidal silica are added (aqueous colloidal sols).

Alternatively, alkoxide based sol-gel systems may be used solely or in combination with the colloidal materials. An example for the silicate system is TEOS (teraethylorthosilicate) in ethanol. Upon addition of water, the TEOS is hydrolyzed to form a silicate network glass precursor. Due to the relatively high cost of alkoxides, the colloidal approach is preferred for the present invention.

Silicate sols tend to gel when pH is lowered below approximately 11, so mixing is done slowly under high speed conditions. As an alternative to pH induced gelation exhibited by colloidal silicates, gelation of the colloidal sol-gel glass formers may also be induced by rapid dehydration or drying.

At this point a prescribed filler material is added and the system is subjected to additional high shear mixing or milling (e.g., ball mill, colloid mill, stone mill). The mixture material at this point is a thixotropic suspension. Viscosity is measured by a rotating spindle viscometer (Brookfield) at various shear rates.

The mixture is then dried and granulated to form individual composite particles of filler with the colloidal glass precursor. Drying and granulation can be by various methods (pan drying followed by crushing and sieving; pan pelletization; fluidized bed drying; extrusion followed by drying, crushing and sieving) The preferred process is spray drying (e.g., a gas-fired, spray dryer at 150 C using a rotary atomizer). This process can yield spherical particles with a median size of 5 to 100 microns and a preferred median size of 30 to 50 microns.

Since the product is granulated, the fines generated in this process are primarily combined in composite particles. This type of operation has the advantage that it allows a variety of sol-gel glass compositions to be prepared in the granulation equipment without the contamination that is often experienced in the conventional glass melting processes (conventionally, melters are dedicated to families of enamel type glasses based on composition; in spite of this, losses to transitions material are always experienced).

A second major benefit of this process arises from the fact that all of the components are coated by the sol-gel glass former. Problems due to resistivity differences of individual frits and poor encapsulations of non-glass components are virtually eliminated.

The granulated powders are collected after drying in a cyclone separator and the fines (generally less than 5 microns) are classified and collected in a secondary filter. The powder is then screened through an appropriate mesh (200 to 325 mesh) to remove any coarse particulate. At this point the fine and coarse materials may be returned to the original mixture.

The materials are then generally heat treated at a temperature of 500 C to decompose hydroxides and any salts. This is generally done in a rotary calciner. It is important that the material not be fully densified or melted by this heat treatment, as some potential energy would be lost that is advantageous to promoting a low firing temperature during the final processing.

If the powders are to be used in electrostatic spraying applications, they are surface treated or coated with siloxanes (0.1 to 0.5% by weight) to impart hydrophobicity and the required high resistivity. This may be done in a heated blender.

To try to ensure that the desired physical properties of the resulting powders have been achieved, selected samples are periodic monitored by measuring their properties such as: Resistivity (Model 465 Powder Resistivity Meter—Industrial Development Bangor), Fluidity (Fluidimeter AS 100—Sames) and Powder Adherence properties.

The actual workability or suitability of the resulting powders for their intended application is assessed by coating (e.g., dry electrostatic spraying (equipment: Nordson, ITW Gema, etc.), dusting, wet process) a sample of the powders only a steel plates. The plates may be coated (in the case of a decorative covercoat) or raw in the case of a system which contains oxides (cobalt, nickel etc) to promote adherence of the fired glass to the steel.

The coated plates are then placed in a furnace and heated at temperatures from 650 C to 850 C for times from 3 to 10 minutes depending upon the coating's chemical composition. The fused coatings can be tested for their color, acid resistance (PEI citric acid spot test), gloss and enamel adherence (drop ball test).

To more specifically illustrate the present invention, the following non-limiting examples are provided, wherein all parts are by weight unless otherwise specified:

### EXAMPLE 1

A dry electrostatically sprayable, enamel coating powder (consisting of: 80% —powdered soda-lime-silica glass (filler) and 20%—colloidal sol-gel derived glass (with a nominal composition of 60% SiO₂, 25% B₂O₃ and 15% Na₂O)) was prepared in the following manner.

Component A was prepared by dissolving 45.7 gms of boric acid in 200 ml of hot water at 90 C.

In a separate container, Component B is prepared: a sodium silicate sol (161.6 grams of Stixxso RR, PQ Corporation), a colloidal silica sol (36.3 grams of Nyacol 830, PQ Corporation) and 100 ml of water are combined with stirring. To this mixture, 400 grams of powdered soda-lime-silica glass (325 mesh) was added while stirring.

Components A and B were then combined in a high shear mixer to yield a thixotropic suspension. This suspension was then converted to a fine powder by spray drying at 150 C using a centrifugal atomizer.

The resultant powder was sieved through 200 mesh and then heat treated at 500 C for one half hour to completely dehydrate the powder and decompose any salts present.

The heat treated powder was then placed in a powder blender equipped with choppers. A methyl hydrogen siloxane (0.5% by weight of GE Silicones 1040 DF) was then added to the powder while blending to impart hydrophobicity to the powder and increase its resistivity for electrostatic spraying.

The powder was then applied to pre-enameled steel plates using commercial electrostatic application equipment (Nordson Corporation) and fired at temperatures ranging from 700 to 820 C for times from three to five minutes.

The resultant fired enamel coating was smooth, continuous and transparent. The fired surface exhibited an acid resistance of AA as determined by the PEI Citric Acid spot test.

### EXAMPLE 2

An enamel coating powder with 70% soda-lime-silica powdered glass, 10% titania opacifier and 20% colloidal sol-gel derived glass with a nominal composition as indicated in Example 1 was prepared as follows.

Component A was prepared as detailed in Example 1. To prepare Component B, the silicate sols were mixed as detailed in Example 1. To the silicate sol, 350 grams of powdered soda-lime-silica glass (325 mesh) and 50 grams of titania (R 100, DuPont) were added while stirring.

The two components were combined as described in Example 1 to yield a thixotropic suspension. This suspension was then converted to a fine powder and further processed as detailed in Example 1.

The resultant fired enamel coating was smooth, continuous and white with an acid resistance of AA as determined by the PEI Citric Acid spot test.

### EXAMPLE 3

An enamel powder with 65% soda-lime-silica powdered glass and 35% colloidal sol-gel derived glass (with a nominal composition of 54.2% SiO2, 27.2% B₂O₃, 7.6% Na₂O, 7% P₂O₅ and 3% CoO) was prepared in the following manner.

73.16 grams of borax (10 mole H₂O) was dissolved in 100 ml of hot water at 90 C with stirring to form Component A. In a separate container, 150 gm of colloidal silica sol (Nyacol 830), 50 ml of water and 185 grams of powdered soda-lime-silica glass (325 mesh) were combined while stirring. In a separate container, 3.64 grams of Co(OH)₂ (OMG) were dissolved in 11.76 grams of 85% phosphoric acid. The Co(OH)₂/phosphoric acid mixture was then added to the silicate sol/powdered glass suspension to yield Component B.

The two components were combined as described in Example 1 to yield a thixotropic suspension. The suspension was then converted to a fine powder and further processed as detailed in Example 1.

The resultant fired enamel was opaque and blue and exhibited an A acid resistance as determined by the PEI Citric Acid spot test.

### EXAMPLE 4

An enamel powder is prepared as described in Example 1 except that the addition of siloxane was omitted. The resultant powder was then applied by dusting or incorporated into a conventional wet application system as known to those familiar with the art of enameling.

Materials that have been found to be suitable, in certain circumstances, for the formulation of filler in the above examples include:

Glass Powder: Soda lime silica (recycled container or flat glass—preferred), Pyrex, Specially formulated enamel frit powders, Fused silica, Volcanic glass and ash, Flyash and Slag from industrial processes;

Minerals: Quartz, Feldspar, Nepheline syenite, and Spodumene;

Pigments: Titanium dioxide, Zirconium silicate, Calcium fluoride, Iron oxide, Inorganic pigments in general and Interference pigments (treated mica for metallic look);

Metals: Aluminum and alloys, Stainless steel, Iron, Copper, Nickel, High temperature alloys, Zinc, Magnesium, Silicon;

Carbides: Silicon carbide, Tungsten carbide;

Nitrides: Silicon nitride, Titanium nitride, Aluminum nitride, Boron nitride;

Ceramics: Aluminum oxide, Zirconium oxide, Rare earth oxides, Magnesium oxide, Lithium titanate, and Aluminum titanate, and

Additives: chosen to impart color, chemical durability, hardness, modify thermal expansion, modify gloss, modify resistivity as required.

Types of colloidal glass binders that have been found to be suitable in these mixtures include: Borosilicate, Alkali borosilicate, Alkali borophosphosilicate, Soda lime silicate, Alkali silicate, Borophosphosilicate, Phosphosilicate, Phosphate, Borate and Vanadate. Ingredients that can be utilized to formulate these colloidal glass binders include: Colloidal silica, Alkali silicates, Phosphoric acid, Sodium phosphate, Ammonium phosphate, Colloidal alumina, Colloidal zirconia, Colloidal cerium oxide, Colloidal yttrium oxide, Borax, Boric acid, Metal salts (acetates, nitrates, chlorides, sulfates), Hydroxides(calcium hydroxide, bismuth hydroxide), HF, and Fluoboric acid. The composition of the colloidal glass is primarily chosen to modify densification temperature, thermal expansion, gloss, chemical durability.

The ratio of dried sol-gel glass formers to powdered glass and pigment, opacifier, metal, etc. may be from 9:1 to 1:9, but optimally will be from 4:1 to 1:4 depending upon the firing conditions and the desired properties of the final coating.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention that is hereinafter set forth in the claims to this invention.

I claim:

1. A method for making an enamel powder that is used to form on a target surface a vitreous enamel coating having desired decorative and functional properties, said method comprising the steps of:
forming an aqueous suspension of prescribed percentages of sol-gel glass formers, glass filler and additives, wherein said additives are chosen so as give said resulting vitreous enamel coating said desired decorative and functional properties,
converting said suspension into particles having a prescribed particle size distribution, and
heating said particles to drive off water and salt anions that are chemically bound to said particles.

2. The method as recited in claim 1, further comprising the step of:
coating said particles so as to provide said particles with the degree of resistivity required for the use of said particles with dry electrostatic spray systems.

3. The method as recited in claim 1, further comprising the step of:
promoting the gelling of said glass formers.

4. The method as recited in claim 2, further comprising the step of:
promoting the gelling of said glass formers.

5. The method as recited in claim 1, wherein said conversion of said suspension to particles includes the drying and granulating of said suspension.

6. The method as recited in claim 2, wherein said conversion of said suspension to particles includes the drying and granulating of said suspension.

7. The method as recited in claim 3, wherein said conversion of said suspension to particles includes the drying and granulating of said suspension.

8. The method as recited in claim 1, wherein said particles have a median size in the range of 5 to 100 microns.

9. The method as recited in claim 2, wherein said particles have a median size in the range of 5 to 100 microns.

10. The method as recited in claim 4, wherein said particles have a median size in the range of 5 to 100 microns.

11. An enamel coating powder that is used to form on a target surface a vitreous enamel coating having desired decorative and functional properties, said powder comprising:
prescribed percentages of sol-gel glass formers, glass filler and additives, wherein said additives are chosen so as give said resulting vitreous enamel coating said desired decorative and functional properties,
wherein in said powder having particles with a prescribed particle size distribution, and
wherein any excess water and salt anions that were chemically bound to said particles have been driven off.

12. The enamel coating powder as recited in claim 11, further comprising a coating suitable for providing said particles with the degree of resistivity required for use of said powder with dry electrostatic spray systems.

13. The enamel coating powder as recited in claim 11, wherein said particles have a median size in the range of 5 to 100 microns.

14. The enamel coating powder as recited in claim 12, wherein said particles have a median size in the range of 5 to 100 microns.
